(19) United States
(12) Patent Application Publication
(10) Pub. No.: US 2026/0073661 A1
(43) Pub. Date: Mar. 12, 2026

(54) IMAGE PROCESSING APPARATUS AND IMAGE PROCESSING METHOD

(71) Applicant: OLYMPUS MEDICAL SYSTEMS CORP., Tokyo (JP)

(72) Inventor: Ryo INOMATA, Tokyo (JP)

(73) Assignee: OLYMPUS MEDICAL SYSTEMS CORP., Tokyo (JP)

(21) Appl. No.: 19/389,529

(22) Filed: Nov. 14, 2025

Related U.S. Application Data
(63) Continuation of application No. PCT/JP2023/019534, filed on May 25, 2023.

(51) Int. Cl. G06V 10/70; G06T 7/00

(52) U.S. Cl. CPC G06V 10/70; G06T 7/0012; G06T 2207/30092; G06T 2207/30096; G06V 2201/07

(57) ABSTRACT

One or more hardware-based processors are configured to: determine, in an image, that a first organ is included, and whether a second organ different from the first organ and an endoscope are further included; when determining that the endoscope is included in the image, and one of two types of organs is located at a center of the image and another is located at an outer periphery of the image, identify an organ appearing on a side of the center as the first organ, and apply an AI for first organ to the organ appearing on the side of the center; and when the endoscope is not included in the image, identify an organ appearing on a side of the outer periphery as the first organ, and apply the AI for first organ to the organ appearing on the side of the outer periphery.

### CROSS REFERENCE TO RELATED APPLICATION

This application is a continuation application of PCT/JP2023/019534 filed on May 25, 2023, the entire contents of which are incorporated herein by this reference.

### FIELD

The present disclosure relates to an image processing apparatus, an image processing method, and an image processing program, which improve an inspection accuracy by endoscopic images.

### BACKGROUND

In recent years, technologies that utilize artificial intelligence (AI) based on image data to support determination made visually by humans in various fields. For example, in the medical field, computer-aided detection (CADe) and computer-aided diagnosis (CADx) are performed using a plurality of inference models generated from endoscopic images of various portions (parts) in a living body to detect lesion regions.

Note that learned models (inference models) for determining a lesion part in a body are generated by deep learning using a multilayer neural network with endoscopic images of each part as training data.

For example, Patent Document 1 (International Publication WO 2022/181748) discloses a technology for performing inspections by switching AI (inference models) according to an observation target.

### SUMMARY

An image processing apparatus according to one aspect of the present disclosure includes: one or more processors that are hardware-based. The one or more processors are configured to: determine, in an image, that a first organ is included, and whether a second organ different from the first organ and an endoscope are further included; when determining that the endoscope is included in the image, and one of two types of organs is located at a center of the image and another of the two types of organs is located at an outer periphery of the image, identify an organ appearing on a side of the center as the first organ, and apply an AI for first organ to the organ appearing on the side of the center; and when the endoscope is not included in the image, identify an organ appearing on a side of the outer periphery as the first organ, and apply the AI for first organ to the organ appearing on the side of the outer periphery.

An image processing method according to one aspect of the present disclosure is an image processing method by an image processing apparatus including one or more processors that are hardware-based. The one or more processors are configured to: determine, in an image, that a first organ is included, and whether a second organ different from the first organ and an endoscope are further included; when determining that the endoscope is included in the image, and one of two types of organs is located at a center of the image and another of the two types of organs is located at an outer periphery of the image, identify an organ appearing on a side of the center as the first organ, and apply an AI for first organ to the organ appearing on the side of the center; and when the endoscope is not included in the image, identify an organ appearing on a side of the outer periphery as the first organ, and apply the AI for first organ to the organ appearing on the side of the outer periphery.

A storage medium according to one aspect of the present disclosure stores a program for causing an image processing apparatus including one or more processors that are hardware-based to perform image processing. The image processing includes: determining, in an image, that a first organ is included, and whether a second organ different from the first organ and an endoscope are further included; when determining that the endoscope is included in the image, and one of two types of organs is located at a center of the image and another of the two types of organs is located at an outer periphery of the image, identifying an organ appearing on a side of the center as the first organ, and applying an AI for first organ to the organ appearing on the side of the center; and when the endoscope is not included in the image, identifying an organ appearing on a side of the outer periphery as the first organ, and applying the AI for first organ to the organ appearing on the side of the outer periphery.

### BRIEF DESCRIPTION OF DRAWINGS

FIG. 1 is a block diagram showing an endoscope apparatus including an image processing apparatus according to a first embodiment of the present disclosure;

FIG. 2 is a flowchart for explaining an operation of the first embodiment;

FIG. 3 is an explanatory diagram showing an inspection target;

FIG. 4 is an explanatory diagram showing how an inspection is performed;

FIG. 5 is an explanatory diagram for explaining an image obtained by the inspection;

FIG. 6 is a flowchart for explaining another operation example of the first embodiment;

FIG. 7 is an explanatory diagram for explaining an image to be obtained by the inspection;

FIG. 8 is an explanatory diagram showing a display example;

FIG. 9 is an explanatory diagram showing another display example;

FIG. 10 is a flowchart showing an operation flow adopted in a second embodiment; and

FIG. 11 is a flowchart showing another operation flow.

### DESCRIPTION OF EMBODIMENTS

Hereinafter, embodiments of the present disclosure will be described in detail with reference to the drawings.

### First Embodiment

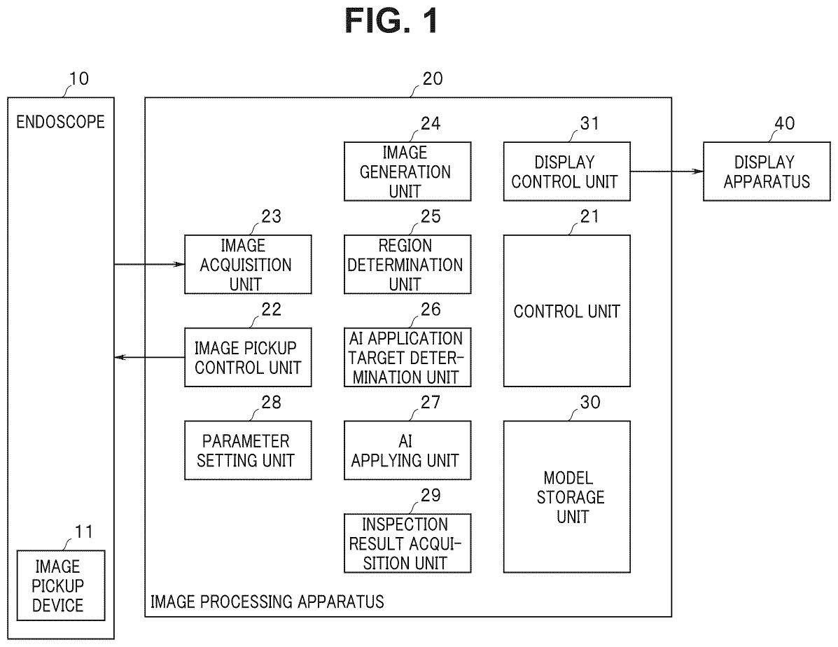

FIG. 1 is a block diagram showing an endoscope apparatus including an image processing apparatus according to a first embodiment of the present disclosure. In the present embodiment, in an image to which AI (inference model) is applied, in a case where images of a plurality types of targets are included as a target to which AI is applied (hereinafter, referred to as AI application target), or in a case where not only the images of the AI application targets but also images of targets to which AI is not applied (hereinafter, referred to as AI non-application target) are included, or the like, an AI processing accuracy is improved by enabling switching between a use or non-use of AI, switching AI to be used, or the like, for image of each target.

In the present embodiment, an example of controlling changes in setting of AI used for diagnosing a lesion part in endoscopy of the upper digestive tract, etc., will be described, but the AI application target is not limited to the upper digestive tract, but may be any part of the human body. Furthermore, the present embodiment can be applied to various image processing apparatuses that apply AI to each part in images, not just the human body. Note that AI is not limited to AI for detecting lesion parts, but also includes various types of AI for improving image quality, such as AI for super-resolution processing.

In the endoscopy of the upper digestive tract, an endoscope inserted through the mouth or the like is advanced into the oral cavity, the pharynx, the upper esophagus, the lower esophagus, and the stomach for observation, and then withdrawn while performing observation as it is returned to the mouth. In endoscopy of the lower digestive tract, a plurality parts in the large intestine (the ascending colon, the sigmoid colon, etc.) are inspected. In addition, in each endoscopy, observation is performed while switching the light source between normal light and special light such as narrow band imaging (NBI) for each part, and using image enhancement technologies such as texture and color enhancement imaging (TXI). In addition to the upper or lower digestive tracts, the small intestine may also be observed during each endoscopy.

Since inspections are performed on a plurality of organs or a plurality of parts, it may be difficult to detect lesions when inference is made using the same model and the same parameters.

### (Endoscopy Method in Comparative Example)

Therefore, in general, in order to improve an inference accuracy (AI processing accuracy), it is necessary to switch AI (hereinafter, also referred to as models) applied to each organ or each part. For example, it is necessary to apply a model or parameters for the oral cavity to the oral cavity, and a model or parameters for the pharynx to the pharynx. In addition, models or parameters for each part in the organs such as the pylorus or the vestibular portion may be prepared. Therefore, in the endoscopy using AI, there is a possibility that time and effort are required to switch the model during the inspection. Therefore, in the image processing apparatus of the comparative example, a method in which the organ is determined based on an inspection image and the model is automatically switched is considered. However, there are cases in which a plurality of organs, parts, or tissues are included in one image near a boundary part between organs, for example, and there is a disadvantage that partial mismatches occur when models are simply switched automatically.

### (Control in Embodiment)

Therefore, in the present embodiment, for example, a state in which a plurality of parts are observed in the same image such as at a boundary portion between organs is determined by using region information on parts and information on other than the parts (such as a scope and a dark portion), an optimal model is applied for each region of the parts, so an inference accuracy is increased to improve a detection accuracy of lesions.

In FIG. 1, the endoscope apparatus includes an endoscope 10, an image processing apparatus 20, and a display apparatus 40. The endoscope 10 includes an image pickup device 11. The endoscope 10, the image processing apparatus 20, and the display apparatus 40 are hardware. The endoscope 10 includes an elongated insertion portion (not shown) having a flexibility and to be inserted into a body, and the image pickup device 11 is provided at a distal end of the insertion portion, for example.

The endoscope 10 includes an optical system (not shown) that guides an object optical image to an image pickup surface of the image pickup device 11. The image pickup device 11 includes a charge coupled device (CCD), a complementary metal-oxide-semiconductor (CMOS) sensor, etc., and photoelectrically converts the object optical image from the optical system to acquire a picked-up image (image pickup signal) of an object. Note that the optical system may include lenses and an aperture (not shown), etc., for zooming and focusing, and may include a zoom (magnification) mechanism and a focusing and aperture mechanism (none of them are shown) for driving the lenses.

In addition, the endoscope 10 may be provided with a forceps port (not shown). In this case, an operator can insert a treatment instrument through the forceps port and project the treatment instrument from a distal end opening of the insertion portion to perform treatment.

The endoscope 10 and the image processing apparatus 20 are electrically connected to each other. The image processing apparatus 20 is provided with an image pickup control unit 22, and the image pickup control unit 22 drives the image pickup device 11. The image pickup device 11 is controlled by the image pickup control unit 22 to pick up an image of the object, and output an image pickup signal to the image processing apparatus 20. Note that the insertion portion of the endoscope 10 is provided with a bending portion (not shown), and the bending portion is configured to be actively bent in up, down, left, and right directions by user operation. An image pickup range of the image pickup device 11 changes depending on an orientation of the distal end of the insertion portion.

The image processing apparatus 20 may include, for example, a control unit 21, the image pickup control unit 22, an image acquisition unit 23, an image generation unit 24, a region determination unit 25, an AI application target determination unit 26, an AI applying unit 27, a parameter setting unit 28, an inspection result acquisition unit 29, a model storage unit 30, and a display control unit 31.

The control unit 21 of the image processing apparatus 20 comprehensively controls each part in the image processing apparatus 20. Respective parts constituting the control unit 21 and the image processing apparatus 20 may be configured by a processor using a central processing unit (CPU) that operates according to a program stored in a memory (not shown), a field programmable gate array (FPGA), etc., or may be a hardware electronic circuit that realizes a part or all of functions of respective parts.

As an example, assume that the image processing apparatus 20 includes a processor and a memory, that are hardware. In this case, the memory is a non-volatile storage medium, and stores, in a non-volatile manner, an image processing program that causes the processor to realize a part or all of functions of the control unit 21, the image pickup control unit 22, the image acquisition unit 23, the image generation unit 24, the region determination unit 25, the AI application target determination unit 26, the AI applying unit 27, the parameter setting unit 28, the inspection result acquisition unit 29, and the display control unit 31. The processor reads and executes the image processing program stored in the memory to operate as a part or all of the control unit 21, the image pickup control unit 22, the image acquisition unit 23, the image generation unit 24, the region determination unit 25, the AI application target determination unit 26, the AI applying unit 27, the parameter setting unit 28, the inspection result acquisition unit 29, and the display control unit 31. The image processing apparatus 20 may include a plurality of processors.

The image acquisition unit 23 captures a picked-up image (moving image or still image) from the image pickup device 11. The image generation unit 24 performs predetermined signal processing, for example, such as color adjustment processing, matrix transformation processing, noise removal processing, and other various signal processing on the captured picked-up image. The display control unit 31 provides the image (endoscopic image) from the image generation unit 24 to the display apparatus 40, and causes the image to be displayed. The display apparatus 40 is a display including a display screen such as a liquid crystal display (LCD), for example. The number of the display apparatuses 40 is not limited but may be plural, and one display apparatus 40 may include a plurality of display parts.

The display control unit 31 displays not only the endoscopic image acquired by the image pickup device 11 but also an inspection result and the like, using AI described later. In other words, the display control unit 31 is provided with an AI processing result (inference result) described later, and displays the AI processing result on the display apparatus 40. For example, the display control unit 31 can also display the inference result indicating the position of the lesion part or a discrimination result of the lesion part on the image (observation image) from the image pickup device 11.

The region determination unit 25 as a region identification unit determines regions of one or more AI application targets (hereinafter, referred to as a target region) included in the image, and acquires region information of the target region. The region determination unit 25 determines each target region included in the image through image analysis processing by AI processing, for example, on the image acquired by the image acquisition unit 23. For example, the region determination unit 25 determines, in the image, a region of a part of the human body (hereinafter, referred to as a part region) and a region of the insertion portion or the dark portion (hereinafter, referred to as a non-part region). In addition, the region determination unit 25 determines a part region for each organ, such as the pharyngolarynx, the esophagus, the stomach, and the duodenum, from the image. The region determination unit 25 also determines the part region of each part in the organs, such as the upper esophagus, the middle esophagus, and the lower esophagus, from the image. Furthermore, the region determination unit 25 determines the non-part region such as the insertion portion of the endoscope 10, the treatment instrument, a lumen, bubbles, a residue, a dark portion, reflected light, and blurring, from the image. The region determination unit 25 further determines the part region where a dye such as indigo carmine has been sprayed.

The model storage unit 30 stores a plurality types of models applied to the organ, the part, the tissues, the dark portion, the residue, the bubbles, the insertion portion, or the like. As described above, these models include various models such as models for lesion detection and diagnosis and models for super-resolution processing. A model stored in the model storage unit 30 may be described as AI.

The AI application target determination unit 26 selects a model conforming to each target region from the model storage unit 30. In addition, the AI application target determination unit 26 determines, using a determination result of the region determination unit 25, the AI application target to which the model stored in the model storage unit 30 is applied, as well as the AI non-application target to which the model is not applied, in the image acquired by the image acquisition unit 23. For example, the AI application target determination unit 26 determines the AI application target and the AI non-application target for the organs, the parts, the tissues, the dark portion, the residue, the bubbles, the insertion portion, or the like included in the image. The AI application target determination unit 26 also determines whether two or more AI application targets are included in the image. A model conforming to a target region of an organ is an example of an AI for organ.

The AI applying unit 27 reads and applies the model selected by the AI application target determination unit 26 (hereinafter, referred to as a target application model) from the model storage unit 30, for each target region acquired by the region information from the region determination unit 25. In other words, the AI applying unit 27 can perform inference processing on the image of each target region in the image, using each target application model.

In the present embodiment, the AI applying unit 27 may apply only the target application model conforming to the target region only to one target region, when a plurality of target regions exist in one image.

The AI applying unit 27 improves an inference accuracy by switching the target application model for each target region, and may use the same target application model with different parameters for a plurality of target regions. In this case, the parameter setting unit 28 is adopted.

The parameter setting unit 28 adjusts and applies the parameters of the target application model for each target region acquired by the region information from the region determination unit 25. In other words, the AI applying unit 27 performs the inference processing using the target application model with parameters optimally adjusted respectively for the images of respective target regions in the image.

### (Reduction in Processing)

The region determination unit 25 and the AI application target determination unit 26 can always determine respective regions such as the organs, the parts, the tissues, the dark portion, the residue, the bubbles, and the insertion portion in the image, and set the target application model suitable for each of the regions. However, processing based on the premise that a plurality of parts always appear in the image increases throughput of a processor.

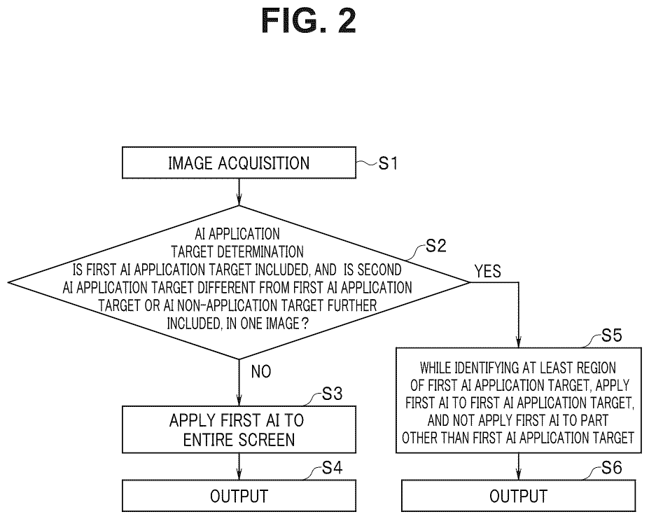

Therefore, the region determination unit 25 first judges whether only a first AI application target appears in the image or an object other than the first AI application target in addition to the first AI application target appear (S2 in FIG. 2). In the latter case, an increase of the throughput of the processor can be suppressed by detecting where is the boundary between the first AI application target and the object other than the first AI application target. Suppressing the increase in the throughput of the processor provides advantages such as an increase in the number of frames for which displaying of the detection result can be applied.

For example, if the first AI application target is the stomach, the objects other than the first AI application target includes the esophagus, the residue, the bubbles, the insertion portion of the endoscope, the treatment instrument, or the like.

If the object other than the first AI application target is the organ, or a part of the organ, a second AI may be applied to the object as a second AI application target. For example, in the above example case, if the esophagus appears as the object other than the first AI application target, an AI for esophagus may be applied to the part of the esophagus.

In other words, when the region determination unit 25 determines a boundary portion, the AI applying unit 27 and the parameter setting unit 28 perform AI processing (inference) using one target application model corresponding to each organ, on other than the boundary portion. In addition, the AI applying unit 27 and the parameter setting unit 28 perform the AI processing on the boundary portion, using the target application model in which parameters based on the determination by the region determination unit 25 and the AI application target determination unit 26 are set.

The inspection result acquisition unit 29 acquires the inspection result based on a processing result of the inference processing by the AI applying unit 27 or the inference processing by the parameter setting unit 28. For example, the inspection result such as a position of the lesion part and a type of the lesion part can be obtained by the inspection result acquisition unit 29. As described above, the inspection result is supplied to the display control unit 31, and the endoscopic image and the inspection result are displayed on the display screen of the display apparatus 40.

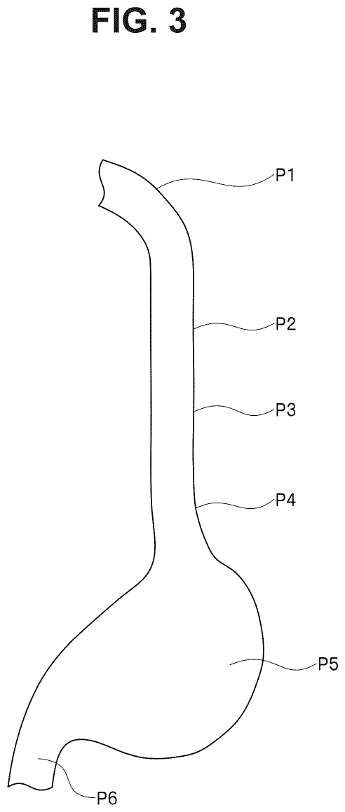

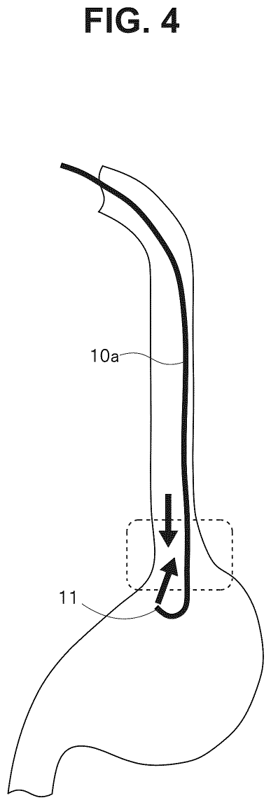

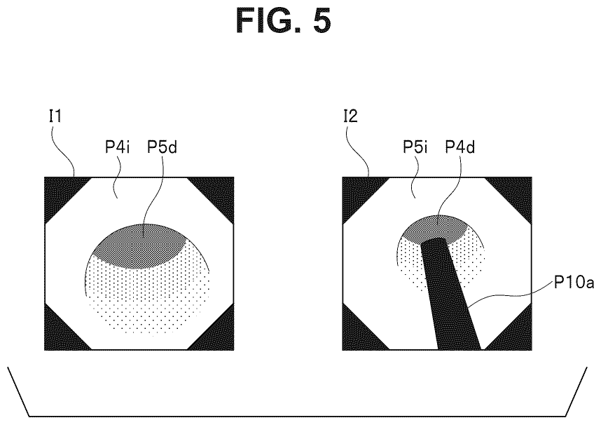

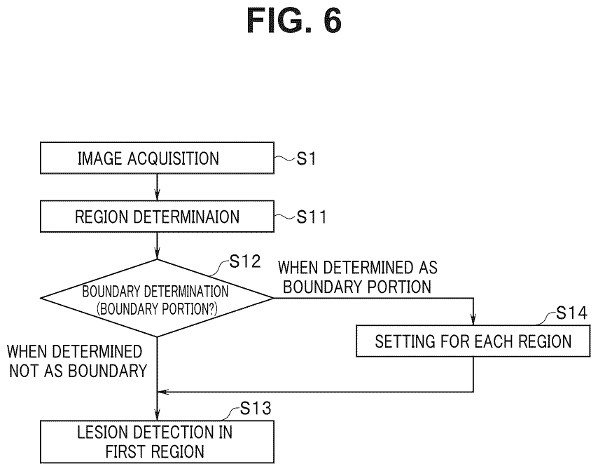

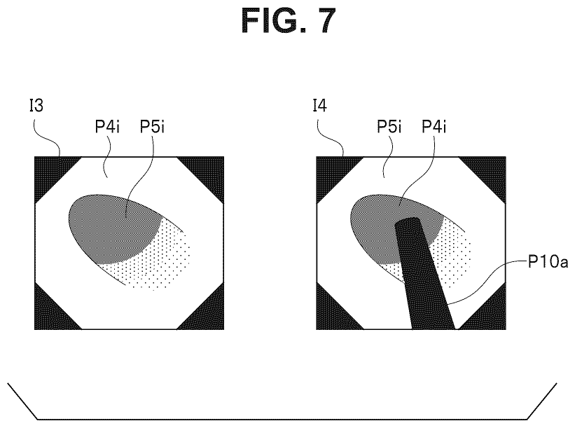

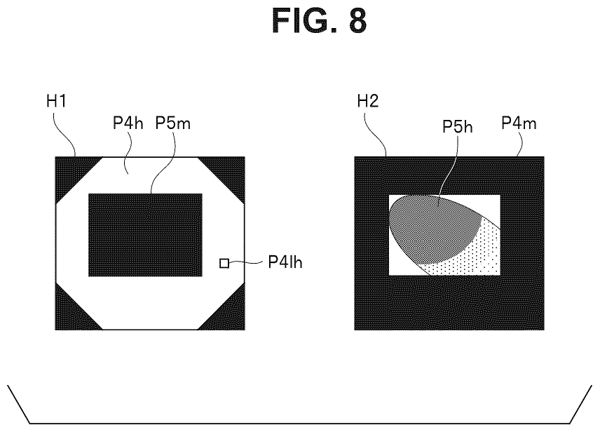

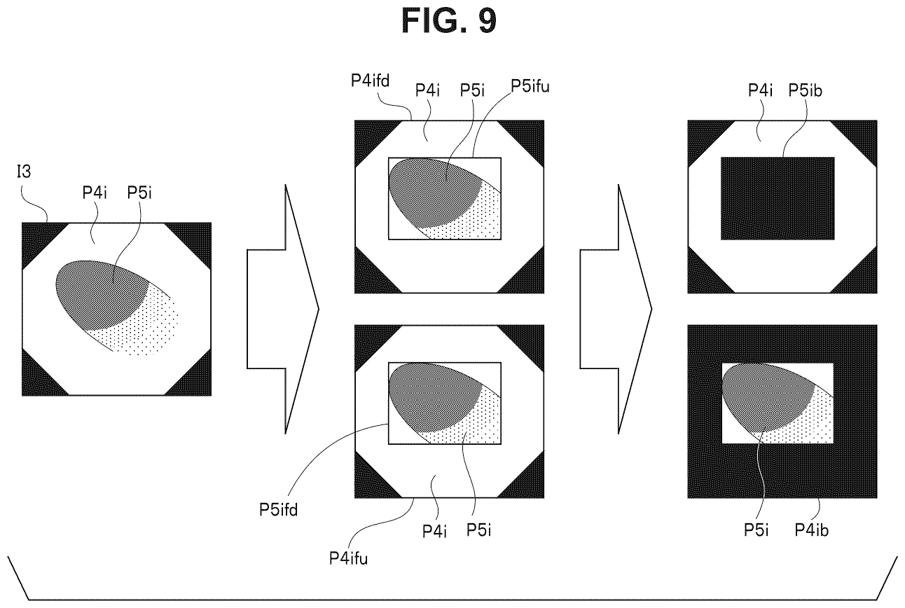

Next, an operation of the embodiment configured in this way will be described with reference to FIG. 2 to FIG. 8. FIG. 2 is a flowchart for explaining the operation of the first embodiment. FIG. 3 is an explanatory diagram showing inspection targets, and FIG. 4 is an explanatory diagram showing how the inspection is performed. FIG. 5 is an explanatory diagram for explaining an image obtained by the inspection. FIG. 6 is a flowchart for explaining another operation example of the first embodiment. FIG. 7 is an explanatory diagram for explaining an image to be obtained by the inspection. FIG. 8 and FIG. 9 are explanatory diagrams each showing a display example.

First, the inspection targets and an inspection method will be described with reference to FIG. 3 and FIG. 4.

The inspection targets are the pharyngolarynx part P1, the upper esophagus P2, the middle esophagus P3, the lower esophagus P4, the stomach P5, and the duodenum P6 shown in FIG. 3. The insertion portion 10a of the endoscope 10 is inserted from the mouth or the like (not shown), and the insertion portion 10a is advanced while picking up images by the image pickup device 11. The image pickup device 11 disposed at a distal end of the insertion portion 10a sequentially picks up images of the pharyngolarynx part P1, the upper esophagus P2, the middle esophagus P3, the lower esophagus P4, the stomach P5, and the duodenum P6. In this case, an observation direction when an image pickup direction of the image pickup device 11 at the distal end of the insertion portion 10a (hereinafter, referred to as the observation direction)(a direction of the arrow in a downward direction in FIG. 4) is directed to an insertion direction of the insertion portion 10a is referred to as an insertion direction, and an observation in which the observation direction is the insertion direction is referred to as an insertion direction observation.

Note that the upper esophagus P2, the middle esophagus P3, and the lower esophagus P4 are not strictly distinguishable in some case. The following description will be made regarding the entire esophagus (mainly, the lower esophagus) as the esophagus P4.

FIG. 4 shows that the insertion portion 10a is bent in the stomach P5, and an image of the esophagus P4 side is picked up from the stomach P5 side. The observation direction in this case, that is, the observation direction when the image pickup direction of the image pickup device 11 is directed to a direction opposite to the insertion direction of the insertion portion 10a is referred to as a removal direction (a direction of the arrow in an upward direction in FIG. 4), and an observation in which the observation direction is the removal direction is referred to as a removal direction observation. Furthermore, images of the duodenum P6, the stomach P5, the esophagus P4, the middle esophagus P3, the upper esophagus P2, and the pharyngolarynx part P1 are sequentially picked up by the image pickup device 11 while withdrawing the insertion portion 10a to obtain endoscopic images of each parts.

The image acquisition unit 23 acquires the image from the image pickup device 11 in step S1 of FIG. 2. The region determination unit 25 and the AI application target determination unit 26 determine the AI application target from the inspection image acquired by the image acquisition unit 23. In addition, the region determination unit 25 and the AI application target determination unit 26 determine that the first AI application target is included in one inspection image, and whether the second AI application target, which is different from the first AI application target, or the AI non-application target is further included in the one inspection image (S2).

Here, suppose that the image pickup device 11 picks up an image of the upper esophagus P2. In this case, only the upper esophagus P2 which is the first AI application target is mainly included in the inspection image (NO determination in S2), and the AI applying unit 27 or the parameter setting unit 28 performs inference applying a first AI, which is an AI for upper esophagus, to the entire screen (S3). Based on the inference result, the inspection result acquisition unit 29 acquires and outputs an inspection result of the lesion part of the upper esophagus P2 (S4).

Furthermore, suppose that the image pickup device 11 picks up an image of the esophagus (mainly, the lower esophagus) P4. In this case, the inspection image may include not only the esophagus P4, which is the first AI application target, but also the stomach P5 which is the second AI application target or the dark portion thereof, in some cases.

The left side of FIG. 5 shows an example of an image I1 obtained when image pickup is performed in the insertion direction from the esophagus P4 side. The image I1 includes an image P4i of the esophagus P4 in the periphery portion, and includes a dark image (the dark portion) P5d of the stomach P5 in the center portion.

In this case (YES determination in S2), in the example of the left side of FIG. 5, while identifying at least the esophagus P4 as a region of the first AI application target, the AI applying unit 27 or the parameter setting unit 28 applies a first AI (AI for esophagus) to the first AI application target. On the other hand, the AI applying unit 27 or the parameter setting unit 28 does not apply the first AI to an image P5d of the dark portion, as the second AI application target or the AI non-application target. That is, the first AI is not applied to a part other than the first AI application target (S5). In this case, the inference applying the first AI, which is the AI for esophagus, is performed on the region determined as the esophagus P4 in the inspection image (S5). Based on the inference result, the inspection result acquisition unit 29 acquires and outputs the detection result of the lesion part of the esophagus P4 (S6).

The right side of FIG. 5 shows an example of an image 12 obtained when the image pickup is performed in the removal direction from the stomach P5 side. The image 12 includes an image P5i of the stomach P5 in the periphery portion, and includes a dark image (the dark portion) P4d of the esophagus P4 and an image P10a of the insertion portion 10a in the center portion.

In this case (YES determination in S2), in the example of the right side of FIG. 5, while identifying the at least stomach P5 as a region of the first AI application target, the AI applying unit 27 or the parameter setting unit 28 applies the first AI (AI for stomach) to the first AI application target. On the other hand, the AI applying unit 27 or the parameter setting unit 28 does not apply the first AI to the parts other than the first AI application target (S5). That is, in this case, the inference applying the first AI, which is the AI for stomach, is performed on the region determined as the stomach P5 in the inspection image (S5). Based on the inference result, the inspection result acquisition unit 29 acquires and outputs the detection result of the lesion part of the stomach P5 (S6).

Next, processing that enables a reduction in a load of the processor will be described with reference to FIG. 6.

When the image acquisition unit 23 acquires the image from the image pickup device 11 (S1), the region determination unit 25 performs region determination in step S11, and performs boundary determination (S12). In other words, the region determination unit 25 performs determination of a part region for each organ, detailed determination of the part region in the organ, and determination of the non-part region.

### (Boundary Determination 1)

The region determination unit 25 determines a region to which AI is applied, based on the part regions, and the non-part regions such as the insertion portion and the dark portion. For example, the region determination unit 25 may determine as the boundary portion when, in one image, an area of one part region is equal to or greater than a threshold value and an area of the dark portion of the non-part regions is equal to or greater than a threshold value. In a case of the example of the left side of FIG. 5 (the insertion direction observation from the lower esophagus), when an area of the image P4i of the esophagus is equal to or greater than the threshold value and an area of the image P5d of the dark portion is equal to or greater than threshold value, that is, when the dark portion (lumen) appears large even when the esophagus P4 is observed, the region determination unit 25 determines that the image is an image of the boundary portion (cardia) between the esophagus P4 and the stomach P5.

Furthermore, when, in one image, an area of one part region is equal to or greater than a threshold value and an area of the dark portion and the insertion portion of the non-part regions is equal to or greater than a threshold value or more, the region determination unit 25 may determine as the image of the boundary portion. In a case of the example of the right side of FIG. 5 (the removal direction observation from the stomach to the esophagus), when an area of the image P5i of the stomach is equal to or greater than the threshold value, and an area of the image P4d of the dark portion and the image P10a of the insertion portion is equal to or greater than the threshold value, the region determination unit 25 determines as the image of the boundary portion (cardia) between the stomach P5 and the esophagus P4.

### (Boundary Determination 2)

The method of boundary determination by the region determination unit 25 is not limited to the above method. For example, as another method of boundary determination, the region determination unit 25 may determine the boundary portion based on a ratio of areas of the part region and the non-part region. For example, the region determination unit 25 calculates, as an effective area, an area obtained by subtracting the area of the non-part region such as the treatment instrument, bubbles, residue, reflected light, and blurring from a total area of the entire image. In addition, the region determination unit 25 calculates, as the effective area, an area obtained by subtracting an area of the part region where a dye such as indigo carmine is sprayed from the total area of the entire image. The region determination unit 25 calculates a ratio of an area of one part region to the effective area and a ratio of an area of the dark portion region to the effective area, and determines as the boundary portion when each ratios are equal to or greater than a threshold value. Furthermore, the region determination unit 25 calculates the ratio of the area of the one part region to the effective area and the ratio of area of the dark portion region and the insertion portion region to the effective area, and determines as the boundary portion when each of the ratios is equal to or greater than a threshold value.

In the example of the left side of FIG. 5, the ratio of the area of the image P4i of the esophagus and the ratio of the area of the image P5d of the dark portion in the image are each greater than a predetermined threshold value, so the region determination unit 25 determines as the image of the boundary portion. In addition, in the example of the right side of FIG. 5, the ratio of the area of the image P5i of the stomach and the ratio of the areas of the image P4d of the dark portion and the image P10a of the insertion portion in the image are greater than respective predetermined threshold values, so the region determination unit 25 determines as the image of the boundary portion.

### (Boundary Determination 3)

The above two methods of boundary determination by the region determination unit 25 determines the boundary region based on the part region and the non-part region. The region determination unit 25 can determine the boundary region even when two or more part regions are included in one image.

FIG. 7 is for explaining an example in such a case. The left side of FIG. 7 shows an example of an image 13 obtained when the image pickup is performed in the insertion direction from the esophagus P4 side. In the image 13, the image P4i of the esophagus P4 is included in the periphery portion, and the relatively bright image P5i of the stomach P5 is included in the center portion. In addition, the right side of FIG. 7 shows an example of an image 14 obtained when the image pickup is performed in the removal direction from the stomach P5 side. In the image 14, the image P5i of the stomach P5 is included in the periphery portion, and the relatively bright image P4i of the esophagus P4 and the image P10a of the insertion portion 10a are included in the center portion.

The region determination unit 25 determines as the image of the boundary portion when areas of the two part regions (the stomach and the esophagus) in the image are equal to or greater than the respective threshold values. For example, as the left side of FIG. 7 (the insertion direction observation from the esophagus to the stomach), the ratio of the area of the image P4i of the esophagus and the ratio of the area of the image P5di of the stomach in the image are greater than the respective predetermined threshold values, the region determination unit 25 determines as the image of the boundary portion. In addition, as the right side of FIG. 7 (the removal direction observation from the stomach to the esophagus), the ratio of the area of the image P5i of the stomach and the ratio of the areas of the image P4i of the esophagus and the image P10a of the insertion portion in the image are greater than the respective predetermined threshold values, the region determination unit 25 determines as the image of the boundary portion.

Note that if the image P10a of the insertion portion exists in the image, the region determination unit 25 may change the threshold value for the boundary determination in consideration of the area of the image P10a of the insertion portion.

In step S12 of FIG. 6, determination is performed whether the inspection image is the boundary portion. If the inspection image is not the image of the boundary portion, the AI applying unit 27 or the parameter setting unit 28 performs the inference on the entire region of the image using the first AI specified by the AI application target determination unit 26 (S13).

On the other hand, if the inspection image is an image of the boundary portion, the AI applying unit 27 or the parameter setting unit 28 performs the inference on the one part region using the first AI specified by the AI application target determination unit 26 (S14). For example, in the example of the left side of FIG. 5, the AI applying unit 27 performs the inference on the image P4i of the lower esophagus using the AI for esophagus as the first AI. Furthermore, in the example of the right side of FIG. 5, the AI applying unit 27 performs the inference on the image P5i of the stomach using the AI for stomach as the first AI.

In the example of the left side of FIG. 5, the parameter setting unit 28 performs the inference on the image P4i of the lower esophagus using AI with parameters optimized for the esophagus as the first AI. Furthermore, in the example of the right side of FIG. 5, the parameter setting unit 28 performs the inference on the image P5i of the stomach using AI with parameters optimized for the stomach as the first AI. Note that as the parameters set by the parameter setting unit 28, reliability at the time of lesion detection determination and weighting coefficients at the time of the inference, etc., are adopted.

### (Display Example)

Next, display examples will be described with reference to FIG. 8 and FIG. 9.

The example H1 of the left side of FIG. 8 shows a display example when the image of the left side of FIG. 5 is acquired by the image acquisition unit 23. In this case, the center of the image is a dark portion, and the AI applying unit 27 or the parameter setting unit 28 performs the inference processing using an AI suitable for the image P4i of the lower esophagus in the periphery of the image. The inspection result acquisition unit 29 detects the lesion part of the esophagus P4 based on the inference result by the AI applying unit 27 or the parameter setting unit 28.

The inspection result acquisition unit 29 performs mask processing for displaying an image based on the result of the inference processing. For example, the inspection result acquisition unit 29 sets a display region frame that identifies a region where the inference using AI is performed, and a not-display region frame that identifies a region other than the region where the inference is performed. The inspection result acquisition unit 29 performs the mask processing to display an endoscopic image in the display region frame, and display a black level in the non-display region frame.

The inspection result acquisition unit 29 sets the display region frame using coordinate information of the region based on the region information from the region determination unit 25. Alternatively, the inspection result acquisition unit 29 may set the display region frame based on a region of pixels whose reliability of the inference processing using AI is equal to or greater than a threshold value.

The inspection result by the inspection result acquisition unit 29 is supplied to the display control unit 31. The display control unit 31 performs display P4h corresponding to the image of the esophagus P4, as shown in the left side of FIG. 8. Display P4lh indicating the detection result of the lesion part is also included in the display P4h. In addition, the display control unit 31 performs black level display P5m corresponding to a region at a center portion of the image, for which the inference processing is not performed because it is a dark portion. In other words, the display control unit 31 performs display in which a region for which the inference processing is not performed is masked.

The example of the right side of FIG. 8 shows a display example when an image of the left side of FIG. 7 is acquired by the image acquisition unit 23. In this case, the center of the image is the relatively bright image P5i of the stomach, and the AI application target determination unit 26 selects an AI conforming to the image P5i, and the inference processing using the AI conforming to the image P5i of the stomach in the center of the image is performed. The inspection result acquisition unit 29 detects a lesion part of the stomach P5 based on the inference result of the AI applying unit 27 or the parameter setting unit 28.

The inspection result by the inspection result acquisition unit 29 is supplied to the display control unit 31. The display control unit 31 performs, for example, display P5h corresponding to the image of the stomach P5, as shown in the right side of FIG. 8, and performs black level display P4m in the region of the esophagus P4 in the periphery of the image, for which the inference processing is not performed. In other words, the display control unit 31 performs display in which a part of a region for which the inference processing is not performed is masked. Such mask processing allows the inspection result of the parts of interest to be displayed in an easily viewable manner.

### (Other Display Example)

FIG. 9 shows an example when the image of FIG. 7 is captured.

The left side of FIG. 9 shows an example of, when the image of the left side of FIG. 7 is captured, a case in which the AI applying unit 27 and the parameter setting unit 28 perform the processing using the AI for esophagus conforming to the image P4i of the esophagus, or the processing using the AI for stomach conforming to the image P5i. The inspection result acquisition unit 29 performs the mask processing for displaying an image based on the result of the inference processing. For example, the inspection result acquisition unit 29 sets the display region frame that identifies a region for which the inference using AI is performed and the non-display region frame that identifies a region other than the region for which the inference is performed. In the upper side of the center of FIG. 9, the example in which a display region frame P4ifd based on the image P4i of the lower esophagus and a non-display region frame P5ifu based on the image P5i of the stomach are set is shown. In the lower side of the center of FIG. 9, an example in which a non-display region frame P4ifu based on the image P4i of the lower esophagus and a display region frame P5ifd based on the image P5i of the stomach.

The inspection result acquisition unit 29 performs the mask processing to display the endoscopic image in the display region frame and display the black level in the non-display region frame. The inspection result by the inspection result acquisition unit 29 is supplied to the display control unit 31. The display control unit 31 displays the endoscopic image in the display region frame specified by the inspection result acquisition unit 29, and the black level in the non-display region frame. As a result, in response to the setting on the upper side of the center of FIG. 9, the image P4i of the lower esophagus is displayed in the periphery of the image, and the black level image P5ib is displayed in the center of the image. Furthermore, in response to the setting on the lower side of the center of FIG. 9, the image P5i of the stomach is displayed in the center of the image, and the black level image P4ib is displayed in the periphery of the image.

As above, in the present embodiment, even if a plurality of AI application targets or the AI non-application target are included in the image to which AI is applied, the inference processing using an AI conforming to the required AI application target can be performed, and the inference accuracy can be increased and reliable diagnosis, etc., are possible.

### Second Embodiment

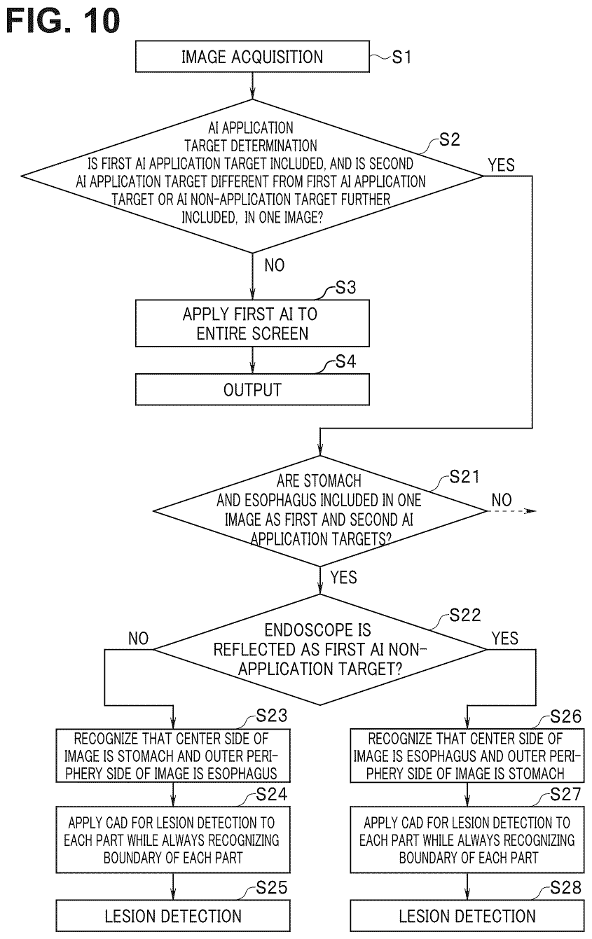

FIG. 10 is a flowchart showing an operation flow adopted in a second embodiment. In FIG. 10, the same procedures as in FIG. 2 are denoted by the same reference signs and descriptions thereof are omitted. A hardware configuration of the present embodiment is the same as that of the first embodiment.

In the first embodiment, the example is described in which the first AI is applied to the first AI application target, and AI is not applied to the second AI application targets other than the first AI application target and the AI non-application target. For example, in the boundary portion of the cardia, control is performed in which the inference using the AI suitable for the esophagus is performed at the time of the insertion direction observation, and the inference using the AI suitable for the stomach is performed at the time of the removal direction observation. In contrast, in the second embodiment, AI suitable for each of the first and second part regions in one image is applied. For example, as the example of FIG. 7, when a plurality of parts in the boundary portion are relatively brightly picked up, the inference using an AI suitable for each part is performed. In this case, the present embodiment enables reliable recognition of the plurality of AI application targets.

In step S2 of FIG. 10, the region determination unit 25 and the AI application target determination unit 26 determine the AI application target from the inspection image acquired by the image acquisition unit 23. In addition, the region determination unit 25 and the AI application target determination unit 26 determine, in the one inspection image, that the first AI application target is included, and whether the second AI application target different from the first AI application target or the AI non-application target is further included (S2). In a case of YES determination in step S2, the region determination unit 25 determines whether images of the stomach and the esophagus are included in the one image as the first and second AI application targets (S21). The region determination unit 25 can almost certainly determine whether the images of the stomach and the esophagus are included in the one image. Note that at this stage, it is only known that the images of the stomach and the esophagus are included in the image, and the region determination unit 25 does not determine the regions of the stomach and the esophagus.

As a result of the determination in S21, when the region determination unit 25 determines that the images of the stomach and the esophagus are not included in the image (NO in S21), the region determination unit 25 performs processing to select an AI conforming to the part included in the image (not shown). When the images of the stomach and the esophagus are included in the image, the region determination unit 25 determines in the next S22 whether the endoscope (insertion portion) as the first AI non-application target appears in the image.

As shown in FIG. 7, the image P4i of the esophagus and the image P5i of the stomach appear in the cardia part. Furthermore, in a case of the removal direction observation from the stomach to the esophagus, the image P10a of the insertion portion may appear. The region determination unit 25 determines in S22 whether the image is an image at the time of the insertion direction observation or an image at the time of the removal direction observation, depending on whether the image P10a of the insertion portion is included in the image. Note that features of the image P10a of the insertion portion is significantly different from features of the image of organ parts, so the region determination unit 25 can relatively easily distinguish the image P10a of the insertion portion.

When the region determination unit 25 determines that the image P10a of the insertion portion does not appear in the image in S22, the region determination unit 25 determines that the image is an image at the time of the insertion direction observation obtained by picking up an image of the stomach P5 from the esophagus P4 side. In this case, as shown in the left side of FIG. 7, the image P4i of the esophagus P4 is included in the periphery portion, and the relatively bright image P5i of the stomach P5 is included in the center portion. Therefore, in this case, the region determination unit 25 recognizes that the center side of the image is the stomach, and an outer periphery side of the image is the esophagus (S23). The region determination unit 25 always recognizes the boundary of each part, and the AI application target determination unit 26 selects an AI suitable for each region. The AI applying unit 27 and the parameter setting unit 28 apply an AI, for example, a CAD for lesion detection to each part (S24). The inspection result acquisition unit 29 performs lesion detection for the region of the stomach and the region of the esophagus (S25).

In addition, when the region determination unit 25 determines that the image P10a of the insertion portion appears in the image in S22, the region determination unit 25 determines that the image is an image at the time of the removal direction observation obtained by picking up an image of the esophagus P4 from the stomach P5 side. In this case, as shown in the right side of FIG. 7, the image P5i of the stomach P5 is included in the periphery portion, and the relatively bright image P4i of the esophagus P4 and the image P10a of the insertion portion 10a are included in the center portion. Therefore, in this case, the region determination unit 25 recognizes that the center side of the image is the esophagus, and the outer periphery side of the image is the stomach (S26). The region determination unit 25 always recognizes the boundary of each part, and the AI application target determination unit 26 selects an AI suitable for each region. The AI applying unit 27 and the parameter setting unit 28 apply an AI, for example, a CAD for lesion detection to each part (S27). The inspection result acquisition unit 29 performs lesion detection for the region of the stomach and the region of the esophagus (S28).

In the second embodiment, even when the plurality of AI application targets are included in the image, the AI processing using an AI conforming to each of the AI application targets is performed. Therefore, the display control unit 31 may display the endoscopic image as is without performing the masking processing. Note that in the second embodiment, as in FIG. 9, the image may be displayed by the mask processing.

In this way, in the present embodiment, even when the plurality of AI application targets are included in the image to which AI is applied, the inference processing using an AI conforming to each of the AI application targets can be performed, and the inference accuracy can be improved and reliable diagnostic, etc., are possible.

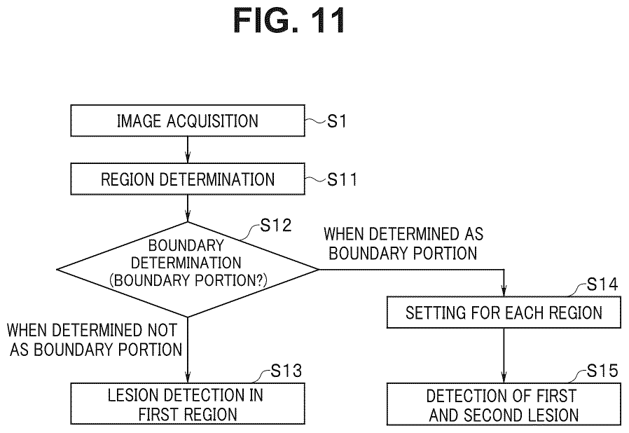

Note that the present embodiment can be applied to FIG. 6 in which the load on the processor is reduced. FIG. 11 is a flowchart showing an operation flow in this case. In FIG. 11, the same procedures as in FIG. 6 are denoted by the same reference signs, and descriptions thereof are omitted.

The flow in FIG. 11 is different from the flow in FIG. 6 in that step S15 is added. In step S14, when the inspection image is an image of the boundary portion, the AI applying unit 27 or the parameter setting unit 28 performs processing using an AI specified by the AI application target determination unit 26 for each part region. For example, in the example of the left side of FIG. 7, the AI for esophagus is selected as the first AI for the image P4i of the lower esophagus, and the AI for stomach is selected as the second AI for the image P5i of the stomach. The AI applying unit 27 and the parameter setting unit 28 detect a first lesion of the esophagus and a second lesion of the stomach by the inference processing using the AI suitable for the esophagus and the inference processing using the AI suitable for the stomach.

The other operation and effects are the same as those in the second embodiment.

The present disclosure is not limited to the above-described embodiments as they are. The present disclosure can be embodied by modifying the constituent elements within the scope not deviating from the gist of the present disclosure at the stage of implementation. In addition, various aspects of the present disclosure can be formed by combining the plurality of constituent elements disclosed in the above embodiments as appropriate. For example, some of the constituent elements may be deleted from all the constituent elements shown in the embodiments. Furthermore, the constituent elements in different embodiments may be combined as appropriate.

Among the technologies described here, many of the controls and functions described mainly in the flowcharts can be set by a program, and the above-mentioned controls and functions can be realized by a computer reading and executing the program. The program can be recorded or stored in whole or in part on a portable medium such as a flexible disk, a compact disc read only memory (CD-ROM), a non-volatile memory and the like, or on a storage medium such as a hard disk or a volatile memory, as a computer program product, and can be distributed or provided at the time of product shipment or via a portable medium or communication line. The portable medium and the storage medium are computer readable non-transitory recording media. The flexible disk, the CD-ROM, the non-volatile memory, and the hard disk are examples of the non-volatile storage medium. Users can easily implement the image processing apparatus of this embodiment by downloading the program via a communication network and installing it on a computer, or by installing it on a computer from a recording medium.

What is claimed is:

1. An image processing apparatus comprising:
one or more processors that are hardware-based, wherein
the one or more processors are configured to:
determine, in an image, that a first organ is included, and whether a second organ different from the first organ and an endoscope are further included;
when determining that the endoscope is included in the image, and one of two types of organs is located at a center of the image and another of the two types of organs is located at an outer periphery of the image,
identify an organ appearing on a side of the center as the first organ, and
apply an AI for first organ to the organ appearing on the side of the center; and
when the endoscope is not included in the image,
identify an organ appearing on a side of the outer periphery as the first organ, and
apply the AI for first organ to the organ appearing on the side of the outer periphery.

2. The image processing apparatus according to claim 1, wherein
the one or more processors are configured to:
when determining that the endoscope is included in the image, and one of two types of organs is located at the center of the image and another of the two types of organs is located at the outer periphery of the image,
identify the organ appearing on the side of the outer periphery as the second organ, and
apply an AI for second organ to the organ appearing on the side of the outer periphery; and
when the endoscope is not included in the image,
identify the organ appearing on the side of the center as the second organ, and
apply the AI for second organ to the organ appearing on the side of the center.

3. The image processing apparatus according to claim 1, wherein
the one or more processors are configured
when an AI non-application target is included in the image,
while identifying a region of the first organ and a region of the AI non-application target,
to apply the AI for first organ to the first organ, and
not to apply the AI for first organ to the AI non-application target.

4. The image processing apparatus according to claim 2, wherein the AI for first organ and the AI for second organ are different models from each other, or a same model set with parameters different from each other.

5. The image processing apparatus according to claim 3, wherein the AI non-application target includes at least one type of a treatment instrument, bubbles, residue, a dark portion, reflected light, a dye, or blurring, and the endoscope.

6. The image processing apparatus according to claim 2, wherein:
the first organ is an esophagus;
the AI for first organ is an AI for esophagus;
the second organ is a stomach; and
the AI for second organ is an AI for stomach.

7. The image processing apparatus according to claim 1, wherein the AI for first organ is an AI to perform lesion detection.

8. An image processing method by an image processing apparatus comprising one or more processors that are hardware-based, wherein
the one or more processors are configured to:
determine, in an image, that a first organ is included, and whether a second organ different from the first organ and an endoscope are further included;
when determining that the endoscope is included in the image, and one of two types of organs is located at a center of the image and another of the two types of organs is located at an outer periphery of the image,
identify an organ appearing on a side of the center as the first organ, and
apply an AI for first organ to the organ appearing on the side of the center; and
when the endoscope is not included in the image,
identify an organ appearing on a side of the outer periphery as the first organ, and
apply the AI for first organ to the organ appearing on the side of the outer periphery.

9. A storage medium configured to store a program for causing an image processing apparatus comprising one or more processors that are hardware-based to perform image processing,
the image processing comprising:
determining, in an image, that a first organ is included, and whether a second organ different from the first organ and an endoscope are further included;
when determining that the endoscope is included in the image, and one of two types of organs is located at a center of the image and another of the two types of organs is located at an outer periphery of the image,
identifying an organ appearing on a side of the center as the first organ, and
applying an AI for first organ to the organ appearing on the side of the center; and
when the endoscope is not included in the image,
identifying an organ appearing on a side of the outer periphery as the first organ, and
applying the AI for first organ to the organ appearing on the side of the outer periphery.
